(19) United States
(12) Patent Application Publication
(10) Pub. No.: US 2026/0288429 A1
(43) Pub. Date: Sep. 24, 2026

(54) OPTIMIZING ARTIFICIAL INTELLIGENCE GENERATED CODE ON THE COMPUTING CONTINUUM

(71) Applicant: NEC Laboratories America, Inc., Princeton, NJ (US)

(72) Inventors: Kunal Rao, Monroe, NJ (US); Giuseppe Coviello, Robbinsville, NJ (US); Mohammad Khojastepour, Lawrenceville, NJ (US); Srimat Chakradhar, Manalapan, NJ (US); Ciro DeVita, Princeton, NJ (US); Gennaro Mellone, Napoli (IT)

(21) Appl. No.: 19/533,802

(22) Filed: Feb. 9, 2026

Related U.S. Application Data
(60) Provisional application No. 63/757,885, filed on Feb. 13, 2025.

(51) Int. Cl. G06F 8/35; G06F 8/41; G06F 21/57

(52) U.S. Cl. CPC G06F 8/35; G06F 8/443; G06F 21/57

(57) ABSTRACT

Systems and methods for optimizing artificial intelligence generated code on the computing continuum. An instruction code that instructs a machine learning model (MLM) can be modified to obtain a modified instruction code that incorporates a dynamic control flow that limits processing of software code based on a target time period. One or more candidate codes based on the modified instruction code can be generated. One or more service paths within the dynamic control flow of the one or more candidate codes can be executed to obtain an optimized generated code having detailed responses within a threshold for downstream tasks by asynchronously performing sub-tasks from the one or more service paths to optimal computing nodes.

### RELATED APPLICATION INFORMATION

This application claims priority to U.S. Provisional App. No. 63/757,885, filed on Feb. 13, 2025, incorporated herein by reference in its entirety.

### BACKGROUND

### Technical Field

The present invention relates to optimizing software code processing and generation, and more particularly to optimizing artificial intelligence generated code on the computing continuum.

### Description of the Related Art

Generative AI has rapidly transformed the software industry, with Large Language Models (LLMs) driving innovations across multiple domains. This surge is fueled by advancements in LLMs. These models have demonstrated state-of-the-art performance in tasks such as question answering, text summarization, and code generation.

### SUMMARY

According to an aspect of the present invention, a method is provided, including, modifying an instruction code that instructs a machine learning model (MLM) to obtain a modified instruction code that incorporates a dynamic control flow that limits processing of software code based on a target time period, generating one or more candidate codes based on the modified instruction code, and executing one or more service paths within the dynamic control flow of the one or more candidate codes to obtain an optimized generated code having detailed responses within a threshold for downstream tasks by asynchronously performing sub-tasks from the one or more service paths to optimal computing nodes.

According to another aspect of the present invention, a system is provided including a memory device, one or more processor devices operatively coupled with the memory device to perform operations including modifying an instruction code that instructs a machine learning model (MLM) to obtain a modified instruction code that incorporates a dynamic control flow that limits processing of software code based on a target time period, generating one or more candidate codes based on the modified instruction code, and executing one or more service paths within the dynamic control flow of the one or more candidate codes to obtain an optimized generated code having detailed responses within a threshold for downstream tasks by asynchronously performing sub-tasks from the one or more service paths to optimal computing nodes.

According to yet another aspect of the present invention, a non-transitory computer program product is provided including a computer-readable storage medium including a program code, wherein the program code when executed on a computer causes the computer to perform operations including modifying an instruction code that instructs a machine learning model (MLM) to obtain a modified instruction code that incorporates a dynamic control flow that limits processing of software code based on a target time period, generating one or more candidate codes based on the modified instruction code, and executing one or more service paths within the dynamic control flow of the one or more candidate codes to obtain an optimized generated code having detailed responses within a threshold for downstream tasks by asynchronously performing sub-tasks from the one or more service paths to optimal computing nodes.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a system for optimizing artificial intelligence generated code on the computing continuum, in accordance with an embodiment of the present invention;

FIG. 2 is a block diagram that shows a computer system for optimizing artificial intelligence generated code on the computing continuum, in accordance with an embodiment of the present invention;

FIG. 3 is a block diagram that shows components of the computer system for optimizing artificial intelligence generated code on the computing continuum, in accordance with an embodiment of the present invention;

FIG. 4 is a block diagram that shows components of the code execution component for optimizing artificial intelligence generated code on the computing continuum, in accordance with an embodiment of the present invention;

FIG. 5 is a flow diagram that shows a high-level overview for optimizing artificial intelligence generated code on the computing continuum, in accordance with an embodiment of the present invention; and

FIG. 6 is a block diagram that shows a practical application of optimizing artificial intelligence generated code on the computing continuum, in accordance with an embodiment of the present invention.

### DETAILED DESCRIPTION OF PREFERRED EMBODIMENTS

In accordance with embodiments of the present invention, systems and methods are provided for optimizing artificial intelligence generated code on the computing continuum.

In an embodiment, an instruction code that instructs a machine learning model (MLM) can be modified to obtain a modified instruction code that incorporates a dynamic control flow that limits processing of software code based on a target time period. One or more candidate codes based on the modified instruction code can be generated. One or more service paths within the dynamic control flow of the one or more candidate codes can be executed to obtain an optimized generated code having detailed responses within a threshold for downstream tasks by asynchronously performing sub-tasks from the one or more service paths to optimal computing nodes.

Different artificial intelligence (AI) models can be optimized for different computing environments, including edge computing. Smaller models provide low-latency responses and are well-suited for edge applications, but they limit accuracy and reasoning capabilities. Conversely, larger models achieve higher precision and better contextual understanding, but their execution is computationally expensive and dependent on cloud connectivity. This trade-off between latency, computational efficiency, and model capability is a key consideration when deploying AI in real-world applications, particularly for latency-sensitive scenarios where immediate decision-making is required.

Traditional deployment approaches to such use cases fall into three categories: cloud-only execution, edge-only execution, and edge-cloud hybrid execution. Cloud-only execution has at least two problems: (a) it consumes too much network bandwidth to send every frame to the cloud, and (b) the response it produces may be delayed or may not arrive when network is poor or non-existent.

Edge-only execution can eliminate these issues, but takes a hit on the quality of output due to limited compute power on the edge.

Edge-cloud hybrid execution balances the two by distributing tasks between edge and cloud, where lightweight tasks run on the edge and heavyweight tasks run in the cloud and only image crops are sent to the cloud, when needed. However, such approaches rely on fixed, a priori placements and decisions about which tasks run on the edge and which are offloaded to the cloud. This rigidity makes them ill-suited for dynamic environments where network conditions fluctuate and missing an alert can have detrimental effects.

To address these issues, the present embodiments can train and utilize machine learning models such as large language models (LLM) to generate code with adaptive control flow and executes it on a hybrid edge and cloud infrastructure such that downstream task outputs can be delivered in real-time, even when network bandwidth is low or non-existent.

Instead of relying on a fixed placement and execution strategy, the present embodiments includes multiple service paths, allowing for dynamic selection of the appropriate execution path at runtime based on latency constraints.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

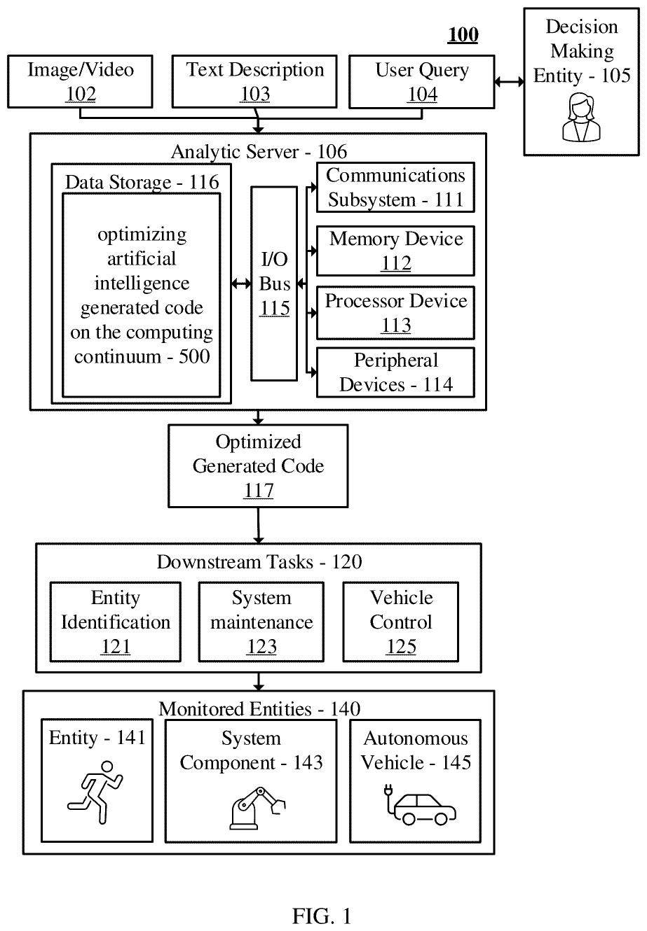

Referring now in detail to the figures in which like numerals represent the same or similar elements and initially to FIG. 1, a block diagram shows a system for optimizing artificial intelligence generated code on the computing continuum, in accordance with an embodiment of the present invention.

In an embodiment using a system 100, monitored entities 140 can include entity 141, system component 143, and autonomous vehicle 145. The monitored entities 140 can generate an image/video 102 and text descriptions 103. The user queries 104 obtained from a decision making entity 105 and the image/video 102 and text descriptions 103 can be transmitted to an analytic server 106 that can implement optimizing artificial intelligence generated code on the computing continuum 500. The analytic server 106 can generate optimized generated code 117 which can be utilized to perform downstream tasks 120.

System 100 can be utilized to perform downstream tasks 120 based on the image/video 102 and user query 104 from a decision-making entity 105. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the image/video 102 or text description 103 (e.g., location images, scene images, entity images such as parts of the entity, etc.) related to the entity 141 can be processed by the analytic server 106 to answer user query 104 based on the optimized generated code 117 by the analytic server 106. The user query 104 can be relevant to the entity 141 such as their attributes (e.g., position, direction of movement, color of clothing, etc.), relationship with other entities within a scene (e.g., proximity, behavior, etc.), relationship with the environment, etc. An AI model can predict future attributes, and relationships of the entity 141.

Based on the predictions of the AI model, a corrective action can be generated. The corrective action can include notifying the decision making entity 105 of the predictions about the entity 141 based on their image/video 102, generating resolutions to an issue caused by the entity (e.g., the entity 141 as a disabled vehicle in a traffic scene and the resolution is the deployment of a repair technician, etc.) of the image/video 102 to help with the decision making process of the decision making entity 105, etc.

In system maintenance 123, image/video 102 or text description 103 (e.g., system logs, test cases, hardware status images, etc.) related to the system component 143 can be processed to answer user query 104 based on based on the optimized generated code 117 for the system component 143 generated by the analytic server 106. The user query 104 can be relevant on how to properly maintain the system component 143, or whether the system component is properly functioning based on the input image/video 102. A corrective action can be generated by the analytic server 106 which can include the answer to the user query 104 (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, redirecting processing of component, etc.) the network system can be autonomously maintained.

In vehicle control 125, image/video 102 (e.g., vehicle part status, traffic scene image, etc.) related to the autonomous vehicle 145 can be processed to answer user query 104. The user query 104 can be relevant to how to control the autonomous vehicle 145 given its environment based on the image/video 102 or text description 103. A corrective action can be generated by the analytic server 106 which can include the answer to the user query 104 to control the proper performance of the autonomous vehicle 145. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle. In an embodiment, the autonomous vehicle 145 can be controlled in response to avoid a predicted event based on a generated trajectory based on the optimized generated code 117 generated by the analytic server 106 such as multi-vehicle collision, accidents, detected road hazards, etc.

In another embodiment, in vehicle control 125, the autonomous vehicle 145 can be controlled to verify and test the functionality of the various components (e.g., advanced driver assistance systems, braking device, accelerator device, cooling device, etc.) of the autonomous vehicle 145 by autonomously controlling the components and generate test data that can be used to fine-tune/train the AI model.

Other downstream tasks and practical applications are contemplated.

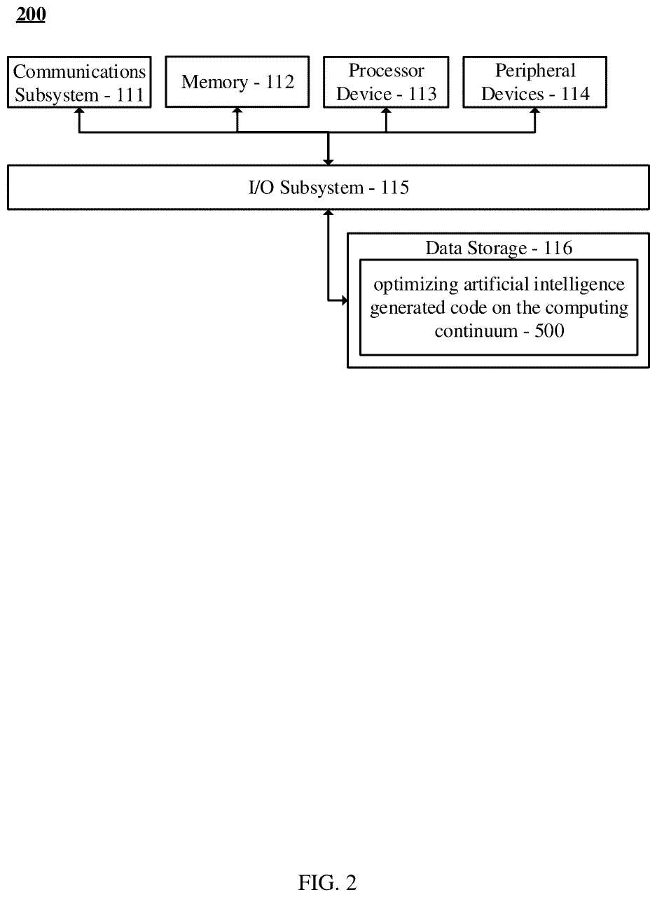

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram shows a computer system for optimizing artificial intelligence generated code on the computing continuum, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single integrated circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for optimizing artificial intelligence generated code on the computing continuum 500. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

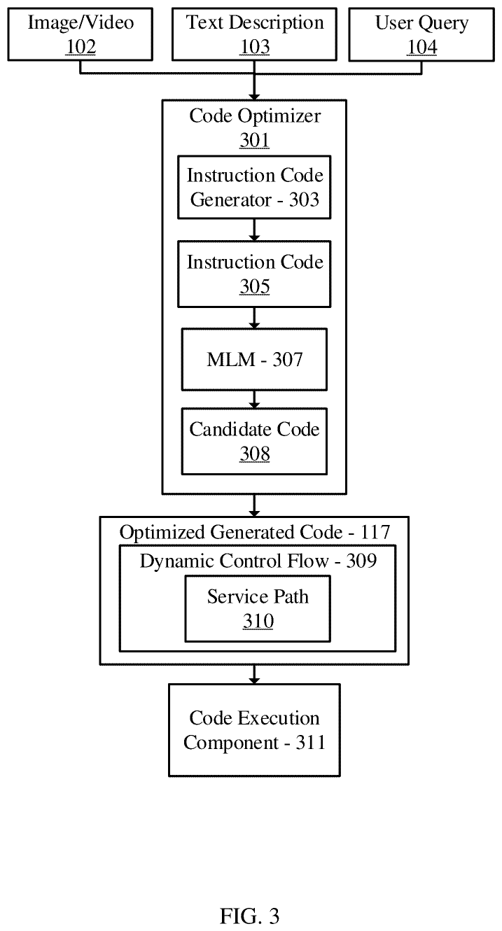

Referring now to FIG. 3, a block diagram shows components of the computer system for optimizing artificial intelligence generated code on the computing continuum, in accordance with an embodiment of the present invention.

In an embodiment, image/video 102, text description 103 and user query 104 can be processed by a code optimizer 301 that generates one or more candidate code 308. An optimized generated code 117 can be determined from the candidate code 308. The optimized generated code 117 can be processed by the code execution component 311 for downstream tasks 120 to generate a downstream task output 130. The optimized generated code 117 can include a dynamic control flow 309 which directs how sub-tasks of the optimized generated code 117 can be executed through one or more service paths 310.

The code optimizer 301 can include an instruction code generator 303 that generates instruction code 305 based on the image/video 102, text description 103 and user query 104. The instruction code 305 can include instructions on how the machine learning model (MLM) 307 can generate codes for the downstream tasks 120. In an embodiment, the MLM 307 can utilize a large language model.

In an embodiment, the MLM 307 can utilize a neural network. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example can be associated with a known result or output. Each example can be represented as a pair, (x, y), where x represents the input data and y represents the known output. The input data can include a variety of different data types and can include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments can be made to the stored weights through back propagation, where the effect of the weights on the output values can be determined by calculating the mathematical gradient and adjusting the weights in a manner that shifts the output towards a minimum difference. This optimization, referred to as a gradient descent approach, is a non-limiting example of how training can be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network, such as a multilayer perceptron, can have an input layer of source neurons, one or more computation layer(s) having one or more computation neurons, and an output layer, where there is a single output neuron for each possible category into which the input example could be classified. An input layer can have a number of source neurons equal to the number of data values in the input data. The computation neurons in the computation layer(s) can also be referred to as hidden layers, because they are between the source neurons and output neuron(s) and are not directly observed. Each neuron in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . w_{n-1,} wₙ. The output layer provides the overall response of the network to the inputted data. A deep neural network can be fully connected, where each neuron in a computational layer is connected to all other neurons in the previous layer, or can have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons in the one or more computation (hidden) layer(s) perform a nonlinear transformation on the input data that generates a feature space. The classes or categories can be more easily separated in the feature space than in the original data space.

In an embodiment, the MLM 307 can utilize a reinforcement learning model that is trained to generate optimized generated code 117. The MLM 307 can be trained based on an action that maximizes the reward to meet a goal. The goal can include generating detailed responses within a response threshold (e.g., a ranking threshold between candidate responses that selects the highest ranked candidate response based on the level of detail within the candidate response) and performing an action having a runtime within a target time period. The action can include the placement of service requests to one or more service paths 110, the execution of service requests to computing nodes, generation/modification of instruction code 305. The reward can include a range of values that depend on the action. The reward can be higher if it corresponds to an action that advances the goal. The reward can be lower if it corresponds to an action that hinders the goal. The training can utilize training losses for reinforcement learning including temporal difference loss, policy gradient loss, and actor-critic loss.

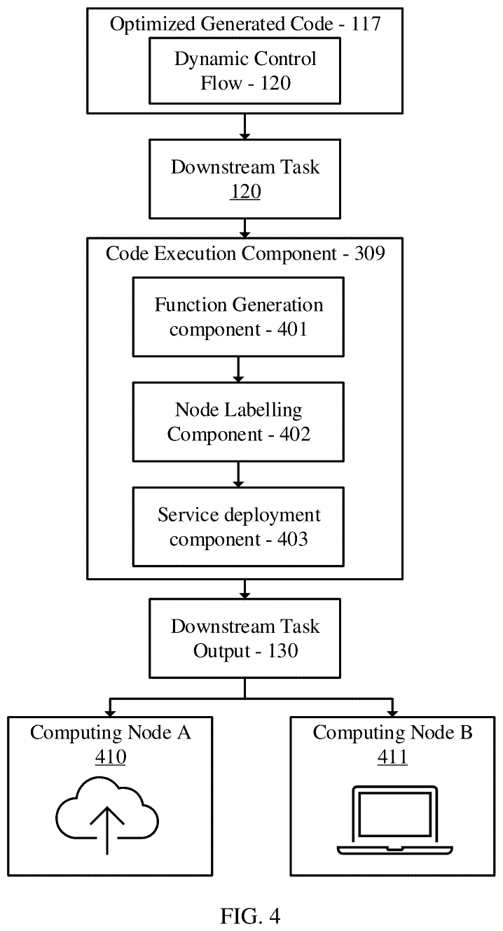

Referring now to FIG. 4, a block diagram shows components of the code execution component for optimizing artificial intelligence generated code on the computing continuum, in accordance with an embodiment of the present invention.

In an embodiment, the optimized generated code 117 can be applied for a downstream task 120. The code execution component 311 processes the optimized generated code 117 for the downstream task 120 to generate the downstream task output 130. The downstream task output 130 can be executed on computing node A 410 or computing node B 411 or a combination of both depending on the dynamic control flow 309 of the optimized generated code 117.

The code execution component 311 can include a function generation component 401, node labelling component 402, and a service deployment component 403.

The function generation component 401 exposes a configuration type for a container orchestration application cluster, for sub-tasks can be deployed to AI models. The configuration type and sub-tasks can correspond to the AI models which can be executed asynchronously by the AI models.

The node labelling component 402 can label the corresponding nodes where sub-tasks and the configuration type for the AI models can be executed. The label generated can include a node-configuration parameter that specifies where the sub-tasks and the configuration type can be executed.

The service deployment component 403 can deploy the sub-tasks and the configuration type with the container orchestration application based on the node-configuration parameter.

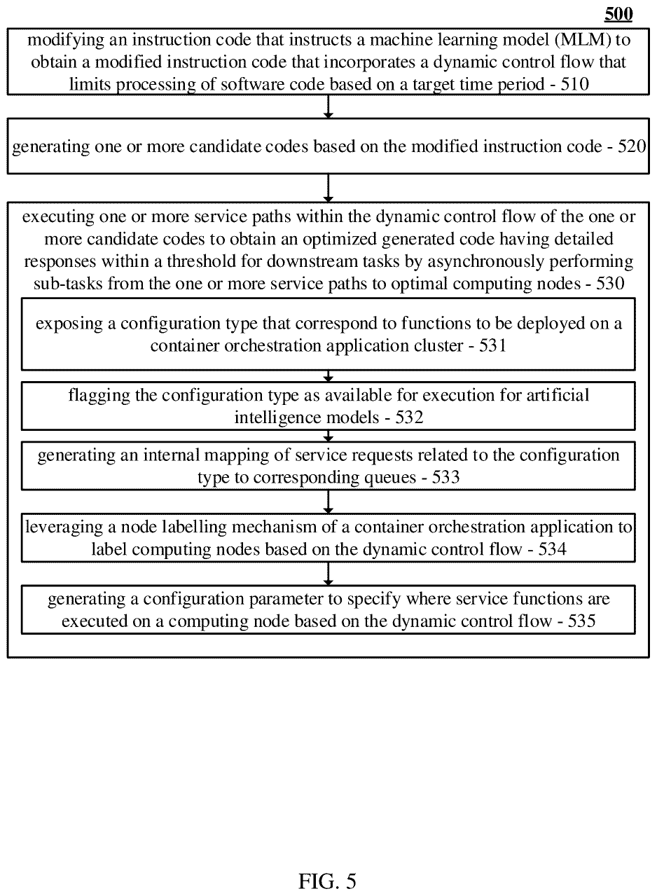

Referring now to FIG. 5, a flow diagram shows a high-level overview for optimizing artificial intelligence generated code on the computing continuum, in accordance with an embodiment of the present invention.

In an embodiment, an instruction code that instructs a machine learning model (MLM) can be modified to obtain a modified instruction code that incorporates a dynamic control flow that limits processing of software code based on a target time period. One or more candidate codes based on the modified instruction code can be generated. One or more service paths within the dynamic control flow of the one or more candidate codes can be executed to obtain an optimized generated code having detailed responses within a threshold for downstream tasks by asynchronously performing sub-tasks from the one or more service paths to optimal computing nodes.

In block 510, an instruction code that instructs a machine learning model (MLM) can be modified to obtain a modified instruction code that incorporates a dynamic control flow that limits processing of software code based on a target time period.

In order to generate the optimized generated code 117, the instruction code 305 that instructs MLM 307 to generate software code can be modified by the code optimizer 301 to incorporate a dynamic control flow 309. The dynamic control flow 309 determines the optimal computing node that executes a sub-task of the generated software code, or the entirety of the generated software code.

In another embodiment, the instruction code can be modified to add details related to compatible AI models for the generated software code.

In an embodiment, the dynamic control flow 309 can include directing heuristics that determines the AI models that can run the generated code as a service request on appropriate computing nodes speculatively. Additionally, the dynamic control flow 309 can include a latency heuristic that determines a target time period (e.g., wait time) for a response from the AI models for the service request. Moreover, the dynamic control flow 309 can include a termination heuristic that terminates the service request when the wait time for the response is not received within the target time period.

For example, the dynamic control flow 309 can include: “the code you generate should have a specific control flow. There will be AI models which run on the edge and on the cloud. Use appropriate AI models to run the code on the edge and in the cloud speculatively. Start execution of both at the same time. Have a target time period of 1.5 second to receive a response from the cloud. If the response from the cloud is not received within 1.5 second, then discard cloud API request and use the edge one.”

In block 520, candidate code with the dynamic control flow can be generated based on the modified instruction code.

In an embodiment, the code optimizer 301 can generate the candidate code 308. The candidate code 308 can be optimized with the dynamic control flow 309 to obtain an optimized generated code 117. The code optimizer 301 can utilize the MLM 307 to generate the optimized generated code 117.

In block 530, one or more service paths within the dynamic control flow of the one or more candidate codes can be executed to obtain an optimized generated code having detailed responses within a threshold for downstream tasks by asynchronously performing sub-tasks from the one or more service paths to optimal computing nodes.

In an embodiment, the optimized generated code 117 can be utilized for the downstream tasks 120 to generate a downstream task output 130. The optimized generated code 117 can include the candidate code 308 having detailed responses within a threshold for downstream tasks by asynchronously performing sub-tasks from the one or more service paths to optimal computing nodes based on the execution of the one or more service paths within the dynamic control flow of the candidate code 308.

In order to execute the distributed code, the code execution component 311 can be utilized. In block 531, the function generation component 401 of the code execution component 311 can expose a configuration type (e.g., kind) called “functions” through which various functions as a “service” to be deployed on an underlying container orchestration application cluster.

In block 532, the configuration type can be flagged as available for execution for artificial intelligence models. In an embodiment, the code execution component 311 can leverage the configuration type to be implemented for corresponding AI models and use cases. The function generation component 401 of the code execution component 311 can configure and set the configuration types in accordance with pre-determined requirements and flag them as available for execution.

In an embodiment, configuration types for corresponding AI models can be set up to be executed asynchronously.

In an embodiment, the different “functions” corresponding to the different AI models are setup and executed asynchronously in which the dynamic mapping of service requests are handled automatically by the function generation component 401 of the code execution component 311. In particular, the code execution component 311 can maintain separate queues for each of the AI models, and process them in an execution mode. For example, the execution mode can include first-come-first-serve manner.

In block 533, an internal mapping of service requests related to the configuration type to corresponding queues can be generated. In an embodiment, the internal mapping of the service requests to queues can be generated by the code execution component 311. The internal mapping of the service requests can include one or more service paths 310 that dictate where the service requests can be executed. For example, the internal mapping can include a service path 310 for service request A to be executed on computing node A, a service path 310 for service request B to be executed on computing node B, and a service path 310 for service request C to be executed on computing node A.

The code execution component 311 can dynamically assign appropriate “pod” instances on appropriate computing nodes (e.g., “edge” or “cloud” machines) to serve function requests during runtime with the node labelling component 402 of the code execution component 311. In another embodiment, the code execution component 311 can perform throughput estimation for hard-to-reach places based on the modeling of the channel and locations of the access points via available throughput measured traces in the proximity of such hard-to-reach places.

In block 534, to execute the optimized generated code 117 on the computing nodes (e.g., edge and cloud) based on the dynamic control flow 309, the node labelling component 402 can leverage a node labelling mechanism of the container orchestration application which can label the machines in the edge with “edge” label and machines in the cloud with “cloud” label for each service path 310 for each queue of the candidate codes 308.

In block 535, based on the dynamic control flow 309 for each function request, the service deployment component 403 of the code execution component 311 can generate a configuration parameter that specify where the function can be executed on the appropriate computing node (e.g., edge or cloud).

In another embodiment, in instances when the configuration parameter is not specified, the code execution component 311 can utilize an execution policy to execute the service request. The execution policy can include the following heuristics:

Machine-hosted heuristic: if the “function” is only on edge or cloud, the machine in “edge” or “cloud” which hosts the specific “function” can be utilized.

Least loaded heuristic: among all the machines in the cloud which can serve the request, the code execution component 311 chooses the one which is least loaded.

Edge-default heuristic: in situations where the “function” is deployed on both, edge and cloud, the code execution component 311 defaults execution to the edge. This can ensure that downstream task outputs 130 can be delivered even in situations where network is non-existent.

In an embodiment, the code execution component 311 can be an add-on to a container orchestration application such as Kubernetes®. The code execution component 311 can perform as an “operator” and expose a new “kind”, called “Function”, through which various functions as a “service” can be deployed on the container orchestration application The functions are stateless and also serverless, since the code execution component 311 manages the servers behind the scene and is completely transparent to someone who writes or invokes the functions.

Various functions can be deployed on code execution component 311, each performing a specific task. Each function forms a container orchestration application “Deployment” and the code execution component 311 creates multiple copies/instances of each function and runs them as “pods” within the container orchestration application.

In an embodiment, there are at least two ways to invoke a function that runs on the code execution component 311:

SDK: the code execution component 311 exposes SDK to implement different functions/services. This SDK has a “run” function, which takes in a callback function as an argument. The code execution component 311 can invoke this callback function, whenever there is a request on a particular function/service.

REST API: Along with SDK, the code execution component 311 can allow interfacing with the function/service through a REST API. The code execution component 311 can host each function/service on a particular endpoint and a “POST” request can be sent with appropriate parameters/inputs. The code execution component 311 then processes the request and returns the response.

In order to execute requests received on different functions/services (either through SDK or REST API), the code execution component 311 internally maintains a queue for each function/service. For example, whenever a request is received on any function, it is put at the end of the queue corresponding to the function. Each queue is processed independently to serve function requests. The code execution component 311 maps each request to one of the available copies (“pods”) of the function and executes them on a first-come, first-serve basis. At the time of execution, if the request is no longer valid, e.g., if the sender no longer needs the response, then the code execution component 311 automatically removes it from the queue. By having separate queues and processing requests simultaneously, not only between various functions, but also within a specific function, code execution component 311 can ensure efficient execution of distributed code on the underlying cluster of machines.

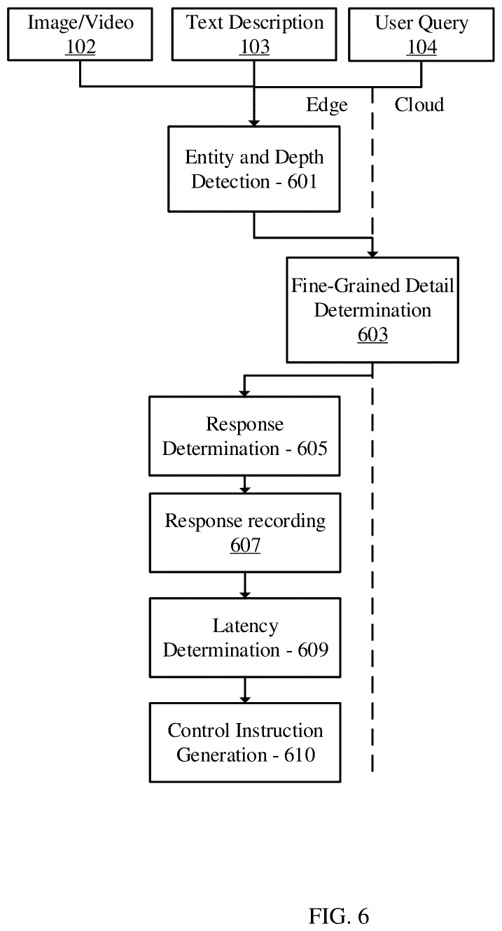

Referring now to FIG. 6, a block diagram shows a practical application of optimizing artificial intelligence generated code on the computing continuum, in accordance with an embodiment of the present invention.

In an embodiment related to a latency-critical use case in marine security, where autonomous vehicles 145 equipped with edge devices monitor waterways for unauthorized vessel activity, boundary violations, and potential security threats. For such applications, the system is tasked with several compute-intensive tasks. The compute-intensive tasks can include continuously analyzing video streams to detect objects in the water, estimating their distance, determining whether they pose a security risk, and making an automatic alert announcement when security breach is identified. The autonomous vehicle 145 can be controlled to effectuate this security policy by closing the distance between the monitored entities 141 and the autonomous vehicle 145. The autonomous vehicle 145 can communicate and utilize the analytic server 106.

In an embodiment, image/video 102, text description 103, and user query 104 can be processed by the analytic server 106 to generate an optimized distributed code 117. During this process, the analytic server 106 determines sub-tasks for the optimized distributed code 117. The sub-tasks can include entity and depth detection 601, fine-grained detail determination 603, response determination 605, response recording 607, latency determination 609, and control instruction generation 610.

The user query 104 can include the following: “Detect boat, calculate distance and find closest boat. Then, for only the closest boat crop, identify if it is a motorized boat for edge execution. For cloud execution, along with checking if it is motorized, also include details of the boat.”

Upon providing this query in natural language, the analytic server 106 can generate optimized distributed code 117 with control flow for execution on edge as well as cloud.

In entity and depth detection 601 instructions are generated to detect monitored entities 141 such as a boat with sensors of the autonomous vehicle 145 (e.g., autonomous boat) and determines the depth. The entity and depth detection 601 can be performed in the appropriate computing node which has been identified as the edge.

In fine-grained detail determination 603, cropped images obtained by the autonomous vehicle 145 can be cropped and be utilized to perform a query to determine whether the boat is motorized or not. The query can be performed on both the edge computing node and the cloud in parallel.

In response determination 605, response from the analytic server is obtained.

In response recording 607, the response from the analytic server is saved and recorded.

In latency determination 609, attributes from the response including the latency can be determined. If the latency is within a latency threshold, then the response is used. However, when the latency threshold is met and no response has been obtained, the service request can be terminated. In another embodiment, when the latency threshold is met, a response that can be obtained with the edge computing node can be utilized.

In control instruction generation 610, control instructions based on the response for the autonomous vehicle 145 can be generated such as stopping, speeding up, changing directions, etc. In another embodiment, the control instructions can include enforcing a security policy when monitored entities cross a spatial threshold.

In another embodiment of the invention, the analytic server 106 can estimate the throughput in the areas where the throughput measurement is not possible or it is hard based on modeling of the channel via collected traces. For example there are areas on the Gulf of Pozzuoli, Naples (Italy), where motorized boats are restricted and not allowed.

In these locations, autonomous vehicles 145 can be deployed to monitor motorized boats and automatically announce an alert, whenever they are seen. In order to enable the function of autonomous vehicles 145 in such a scenario, a nearby area can be measured and then approximate for the particular area. Specifically, the analytic server 106 can collect several traces of network bandwidth measurements in uplink and downlink for the mobile operators in these areas. The traces are collected inland in close proximity of the areas of interest as well as the coastal area while riding on a Ferry from the Port of Pozzuoli to the island of Procida. These areas are the closest physically accessible area where we could go and actually measure the network bandwidth. Using these measurements, the autonomous vehicle 145 can estimate a limited number of access points and estimate their locations and parameters that fit with the measurement traces.

In an embodiment, the analytic server 106 can adapt the standard third generation partnership project (3GPP) channel model and mapping between the channel quality index and throughput is performed based on the 3GPP standard. Using the estimated locations and parameters of the access points, the autonomous vehicle 145 generate traces for the throughput in inaccessible areas. The analytic server 106 can capture the distribution of the throughput and correctly models the fluctuation of the throughput in the same or close-by locations. The analytic server 106 can determine the optimized locations and parameters of the access points as well as the number of such access points.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
modifying an instruction code that instructs a machine learning model (MLM) to obtain a modified instruction code that incorporates a dynamic control flow that limits processing of software code based on a target time period;
generating one or more candidate codes based on the modified instruction code; and
executing one or more service paths within the dynamic control flow of the one or more candidate codes to obtain an optimized generated code having detailed responses within a threshold for downstream tasks by asynchronously performing sub-tasks from the one or more service paths to optimal computing nodes.

2. The method of claim 1, the downstream tasks include controlling an autonomous vehicle with the optimized generated code to enforce a security policy when monitored entities cross a spatial threshold.

3. The method of claim 1, wherein executing the optimized generated code further includes exposing a configuration type that correspond to functions to be deployed on a container orchestration application cluster.

4. The method of claim 3, wherein executing the optimized generated code further includes flagging the configuration type as available for execution for artificial intelligence models.

5. The method of claim 4, wherein executing the optimized generated code further includes generating an internal mapping of service requests related to the configuration type to corresponding queues.

6. The method of claim 1, wherein executing the optimized generated code further includes leveraging a node labelling mechanism of a container orchestration application to label computing nodes based on the dynamic control flow.

7. The method of claim 1, wherein executing the optimized generated code further includes generating a configuration parameter to specify where service functions are executed on a computing node based on the dynamic control flow.

8. A system, comprising:
a memory device; and
one or more processor devices operatively coupled with the memory device to perform operations including:
modifying an instruction code that instructs a machine learning model (MLM) to obtain a modified instruction code that incorporates a dynamic control flow that limits processing of software code based on a target time period;
generating one or more candidate codes based on the modified instruction code; and
executing one or more service paths within the dynamic control flow of the one or more candidate codes to obtain an optimized generated code having detailed responses within a threshold for downstream tasks by asynchronously performing sub-tasks from the one or more service paths to optimal computing nodes.

9. The system of claim 8, the downstream tasks include controlling an autonomous vehicle with the optimized generated code to enforce a security policy when monitored entities cross a spatial threshold.

10. The system of claim 8, wherein executing the optimized generated code further includes exposing a configuration type that correspond to functions to be deployed on a container orchestration application cluster.

11. The system of claim 10, wherein executing the optimized generated code further includes flagging the configuration type as available for execution for artificial intelligence models.

12. The system of claim 11, wherein executing the optimized generated code further includes generating an internal mapping of service requests related to the configuration type to corresponding queues.

13. The system of claim 8, wherein executing the optimized generated code further includes leveraging a node labelling mechanism of a container orchestration application to label computing nodes based on the dynamic control flow.

14. The system of claim 8, wherein executing the optimized generated code further includes generating a configuration parameter to specify where service functions are executed on a computing node based on the dynamic control flow.

15. A non-transitory computer program product comprising a computer-readable storage medium including a program code, wherein the program code when executed on a computer causes the computer to perform operations including:
modifying an instruction code that instructs a machine learning model (MLM) to obtain a modified instruction code that incorporates a dynamic control flow that limits processing of software code based on a target time period;
generating one or more candidate codes based on the modified instruction code; and
executing one or more service paths within the dynamic control flow of the one or more candidate codes to obtain an optimized generated code having detailed responses within a threshold for downstream tasks by asynchronously performing sub-tasks from the one or more service paths to optimal computing nodes.

16. The non-transitory computer program product of claim 15, the downstream tasks include controlling an autonomous vehicle with the optimized generated code to enforce a security policy when monitored entities cross a spatial threshold.

17. The non-transitory computer program product of claim 15, wherein executing the optimized generated code further includes exposing a configuration type that correspond to functions to be deployed on a container orchestration application cluster.

18. The non-transitory computer program product of claim 17, wherein executing the optimized generated code further includes flagging the configuration type as available for execution for artificial intelligence models.

19. The non-transitory computer program product of claim 18, wherein executing the optimized generated code further includes generating an internal mapping of service requests related to the configuration type to corresponding queues.

20. The non-transitory computer program product of claim 15, wherein executing the optimized generated code further includes leveraging a node labelling mechanism of a container orchestration application to label computing nodes based on the dynamic control flow.
